(19) United States
(12) Patent Application Publication
(10) Pub. No.: US 2011/0297339 A1
(43) Pub. Date: Dec. 8, 2011

(54) VEHICLE WINDOW SHADE HAVING VARIABLE OPACITY AND DIAPHANEITY

(76) Inventors: Lydia M. Yi, Fontana, CA (US); Luciano C. Yi, Fontana, CA (US)

(21) Appl. No.: 12/794,048

(22) Filed: Jun. 4, 2010

(51) Int. Cl. B60J 3/00

(52) U.S. Cl. 160/370.21

(57) ABSTRACT

An invention is provided for vehicle window shade having variable opacity and diaphaneity. The invention includes a first piece of fabric and a second piece of fabric, both having a front side and a reverse side. The second piece of fabric is attached at one end to the first piece of fabric such that they overlay each other when unrolled. Both the first piece of fabric and the second piece of fabric have a quantity of hook material disposed around the edge of the front side of the fabric and a quantity of felt disposed around the edge of the reverse side of the fabric. Thus, an end of the vehicle window shade can be attached to a vehicle ceiling via the first quantity of hook material. Typically, the first piece of fabric has a higher level of opacity than the second piece of fabric.

### BACKGROUND OF THE INVENTION

1. Field of the Invention

This invention relates generally to window shades, and more particularly to window shades having variable opacity and diaphaneity for use in homes and vehicles.

2. Description of the Related Art

Today, vehicle window shades often are placed in vehicle windows to reduce the effect of the Sun's rays on a vehicle's passengers. This is particularly true when small children are present, since they frequently are confined to a child's car seat and thus are unable to move to escape the Sun's rays. These windows shades typically take the form of a small piece of material, such as a soft plastic, attached to suction cups, which are themselves held onto a window surface via a vacuum created between the suction up and the smooth, nonporous surface of the vehicle window as illustrated next with reference to FIG. 1.

FIG. 1 is an illustration of a vehicle door 100 having a prior art window shade 101 attached to the vehicle window 104. As illustrated in FIG. 1, the prior art window shade 101 typically includes a piece of shaded material formed in a suitable shape, such as a rectangle, and attached to a plurality of suction ups 102. In use, each suction cup 102 is pressed onto the surface of the window 104, thus fixing the window shade 101 into place on the interior surface of the vehicle window 104. Once the window shade 101 is fixed in place, the window shade 101 provides protection from the Sun's rays for individuals sitting near the vehicle window 104. In addition to temporarily attaching the window shade 101 to the vehicle window 104, the suction cups 102 further allow the window shade 101 to be moved around the interior window surface to adjust for vehicle movement relative to the Sun without harming the interior surface of the window 104. Another typical prior art window shade is a retractable window shade, as illustrated next with reference to FIG. 2.

FIG. 2 is an illustration of a vehicle door 100 having a prior art retractable window shade 200 attached to the vehicle window 104. The prior art retractable window shade 200 of FIG. 2 typically includes a section of shaded material rolled onto a roller 202, which is attached to a plurality of suction ups 102. In use, the suction cups 102 are pressed onto the surface of the vehicle window 104, thus fixing the roller 202 of the retractable window shade 200 into place on the interior surface of the vehicle window 104. Once the roller 202 is fixed in place on the vehicle window 104, a pull cord 204 can be used to unroll a section of the shade material from the roller 202 to provide shade for the interior of the vehicle. The unrolled section of shade material can then be attached to the surface of the vehicle window 104 using a further suction cup 102, thus holding the unrolled section of shade material in place and temporarily preventing it from rolling back up onto the roller 202 of the retractable window shade 200. Thereafter, the retractable window shade 200 provides protection from the Sun's rays for individuals sitting near to the vehicle window 104. Similar to the prior art window shade described with respect to FIG. 1, the suction cups 102 allow the retractable window shade 200 to be moved about the interior window surface to adjust for vehicle movement relative to the Sun without harming the interior surface of the window 104.

Unfortunately, both the prior art window shades discussed above suffer from a number of deficiencies. One problem is the difficulty in moving the window shade once it is applied. More particularly, the suction cup design requires a relatively high degree of effort to remove the vacuum held section cups 102 from the surface of the window. Generally, each suction cup 102 must be individually removed by peeling the edge of the suction cup from the surface of the window to release the vacuum seal beneath the suction cup 102 before the window shade can be repositioned. Typically, this requires the vehicle to be stopped and the door opened to provide room for the removal operation.

Another problem with the prior art window shades described above is the effect heat has on the suction cups 102. Although the suction cups 102 can provide a strong hold once fixed in placed, heat can lead to unexpected failure of the suction cups, resulting in the window shade falling off the surface of the window at inopportune times. Specifically, heat often causes the vacuum seal of the suction cups 102 to fail, thus releasing the suction cup 102 from the surface of the window. Since the window shade typically is used on warm and otherwise hot days to reduce the effects of the Sun's rays on vehicle occupants, failure of the window shades in heat is a particularly troublesome problem.

Further, both window shades described above require the door window to be up. That is, they are incapable of functioning properly without a window surface on which to hold the suction cups. As a result, a user cannot roll down the door window to allow the outside air to cool down the interior of the vehicle while still having the shading effect of the prior art window shade.

Moreover, there is the issue of storage when using the prior art window shades described above. Specifically, the generally stiff material used to maintain the shape of the window shade of FIG. 1 typically requires the window shade to maintain the same shape when stored, thus causing a storage problem when space is not readily available. Although the retractable window shade of FIG. 2 provides better storage options than the window shade of FIG. 1, the retractable window shade still is subject to the dimensions of the roller when being stored. Again, when available storage space is low, storage of the retractable window shade can be a problem.

In view of the foregoing, there is a need for an apparatus that provides protection from the Sun's rays to vehicle occupants while being easily movable from position to position. Moreover, the apparatus should not be adversely affected by heat so as to provide reliable protection in hot and warm environments. Further, the apparatus should be easily storable.

### SUMMARY OF THE INVENTION

Broadly speaking, embodiments of the present invention address these needs by providing an easily storable window shade that includes a plurality of removable attachment means, for example in the form of small hook material from hook and loop fasteners, to attach the window shade to the felt covered surface of a vehicle's ceiling near a desired window. For example, in one embodiment, the vehicle window shade includes a section of fabric having a front side and a reverse side. Disposed on an edge of the fabric on the front side is a temporary attachment means that is capable of attaching to a particular material when coming into contact with it. On an edge of the reverse side of the fabric is a length of loop material, such as felt. The temporary attachment means can be, for example, hook material from a hook and loop fastener that can attach to felt when coming into contact with it, thus allowing the vehicle window shade to be attached to a vehicle ceiling via the hook material. Alternatively, the temporary attachment means can be a magnet that attaches to metal when coming into contact with it. Different types of fabric also can be used so that the vehicle window shade can be opaque or diaphanous.

In a further embodiment, a vehicle window shade having variable opacity and diaphaneity is disclosed. In this embodiment the vehicle window shade includes a first piece of fabric and a second piece of fabric, both having a front side and a reverse side. Here, the second piece of fabric is attached at one end to the first piece of fabric such that they overlay each other when unrolled. Similar to above, both the first piece of fabric and the second piece of fabric have a quantity of hook material disposed around the edge of the front side of the fabric and a quantity of loop material, such as felt, disposed around the edge of the reverse side of the fabric. In this manner, an end of the vehicle window shade can be attached to a vehicle ceiling via the first quantity of hook material. Typically, the first piece of fabric has a higher level of opacity than the second piece of fabric. For example, the first piece of fabric can be opaque, while the second piece of fabric is diaphanous, such as a mesh fabric.

Hence, in this embodiment, the vehicle window shade is created by overlaying the first piece of fabric with the second piece of fabric when both pieces of fabric are unrolled. As a result, the hook material of the second piece of fabric attaches to the felt present on the reverse side of the first piece of fabric. Once attached to one another, the two pieces of fabric operate as a single vehicle window shade. The effective length of vehicle window shade can be adjusted by rolling one end of the vehicle window shade until the desired length is achieved. When rolled together, the felt present on the reverse side of second piece of fabric will attach to the hook material of the first piece of fabric thus keeping the vehicle window shade from unrolling until force is applied to unroll the window shade.

Moreover, the opacity of the vehicle window shade can be adjusted by rolling up only the first piece of fabric while the second piece of fabric remains unrolled and thus down. Similar to above, when rolled up, the felt present on the reverse side of the first piece of fabric will attach to the hook material of first piece of fabric thus keeping the first piece of fabric from unrolling until force is applied to unroll the window shade. In this manner, the vehicle window shade can be adjusted to be opaque when both pieces of fabric are down, diaphanous when the first piece of fabric is rolled up and the second piece of fabric is down, or clear when both pieces of fabric are rolled up. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is an illustration of a vehicle door having a prior art window shade attached to the vehicle window;

FIG. 2 is an illustration of a vehicle door having a prior art retractable window shade attached to the vehicle window;

FIG. 3 is a diagram showing an exemplary vehicle window shade in accordance with an embodiment of the present invention;

FIG. 4 is an illustration showing a vehicle interior having an exemplary vehicle window shade, in accordance with an embodiment of the present invention;

FIG. 5 is an illustration showing a vehicle interior having an exemplary vehicle window shade adjusted using the adjustment means, in accordance with an embodiment of the present invention;

FIG. 6A is a diagram showing a first side of an exemplary vehicle window shade in accordance with an embodiment of the present invention;

FIG. 6B is a diagram showing an alternate embodiment of a first side of an exemplary vehicle window shade in accordance with an embodiment of the present invention;

FIG. 7 is a diagram showing a second side of an exemplary vehicle window shade, in accordance with an embodiment of the present invention; and

FIG. 8 is a diagram showing a vehicle window shade having variable opacity and diaphaneity, in accordance with an embodiment of the present invention.

### DETAILED DESCRIPTION OF THE PREFERRED EMBODIMENTS

An invention is disclosed for an easily storable vehicle window shade capable of blocking and/or diluting sunrays. Broadly speaking, embodiments of the present invention are formed from an easily storable material that includes a plurality of removable attachment means, for example in the form of small hook material, to attach the window shade to the felt covered surface of a vehicle's ceiling near a desired window. Thus, the window shade can block and/or dilute the Sun's rays, and continue to operate when the corresponding window is open. Moreover, in one embodiment, the window shade includes the ability to have variable opacity and diaphaneity selectable by the user.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

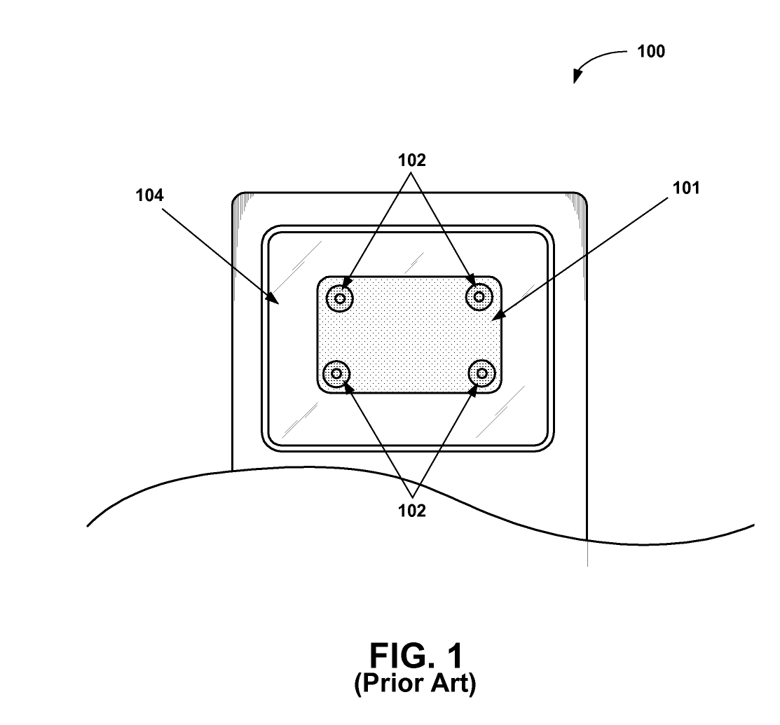

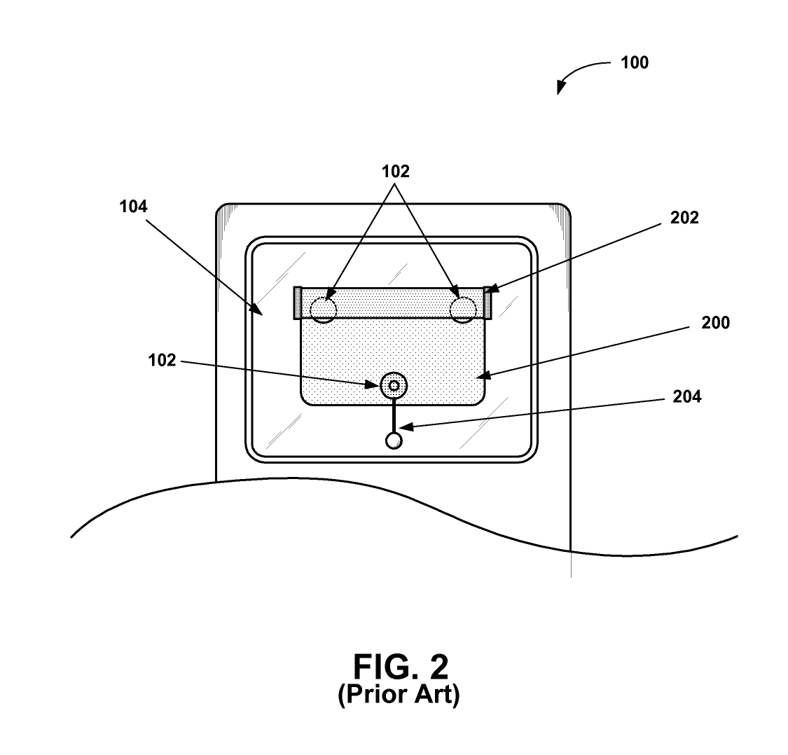

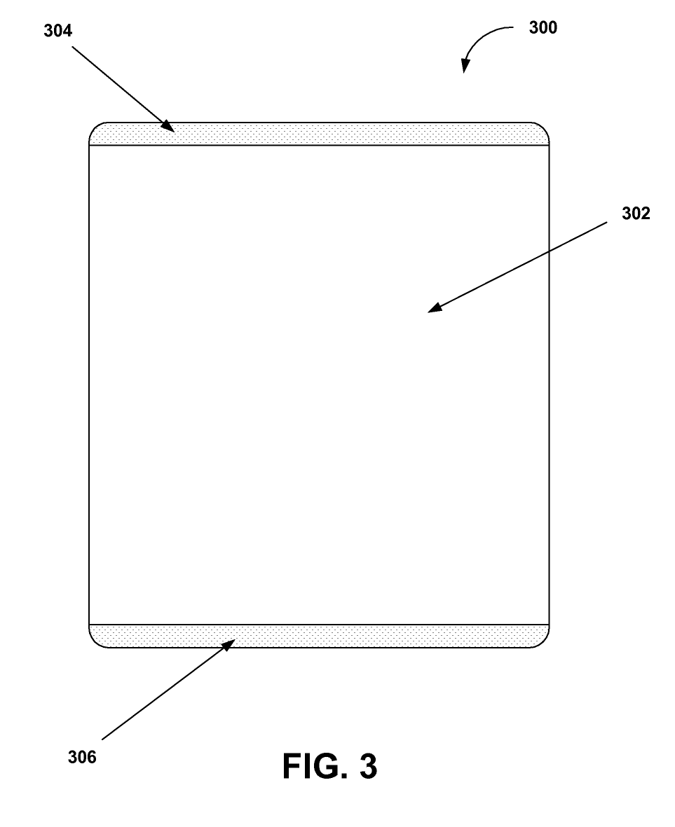

FIG. 1 and FIG. 2 were described in terms of the prior art. FIG. 3 is a diagram showing an exemplary vehicle window shade 300 in accordance with an embodiment of the present invention. As illustrated in FIG. 3, the exemplary vehicle window shade 300 includes an appropriately shaped section of flexible shade material 302 having a temporary attachment means 304 disposed at one end of the flexible shade material 302, and an adjustment means 306 disposed at another end of the flexible shade material 302.

Preferably, the flexible shade material 302 is composed of an easily storable and flexible material such as an opaque or diaphanous section of fabric. Exemplarity fabrics suitable for use included, for example, Cordura, Metallic Brocade, Quilter's Batiks, Knits Cotton, Silky Solids and Prints, Satin Taffeta, Crinkle Chiffon, Crepe/Crepon, Fleece, Cotton & Polyester, Mesh, Tissue Lame, and Polyester & Spandex. In this manner, the window shade 300 can be easily folded, rolled up, or collapsed in almost any manner for storage when space is not readily available for larger items.

In one embodiment, the temporary attachment means 304 is a length of hook material often utilized in hook and loop fasteners. A hook and loop fastener generally comprises two portions: a hook portion and a loop portion. The hook portion typically is a portion of fabric covered with very small nylon hooks. The loop portion typically is a portion of fabric covered with small loops of thread like material. When the hook portion and the loop portion are pressed together, the small hooks on the hook portion catch the small thread like loops of the loop portion of the fastener and hold the to portions together. However, when force is applied to separate the hook portion from the loop portion, the hooks disengage from the loops relatively easily making a hook and loop fastener ideal as a temporary attachment means. Hence, hereinafter, the term “hook material” shall mean the hook material utilized in hook and loop fasteners, both having small hooks alone, or having small hooks combined with an amount of loop material together. In addition, hereinafter, the term “loop material” shall mean the loop material utilized in hook and loop fasteners, both having small loops alone, or having small loops combined with an amount of hook material together.

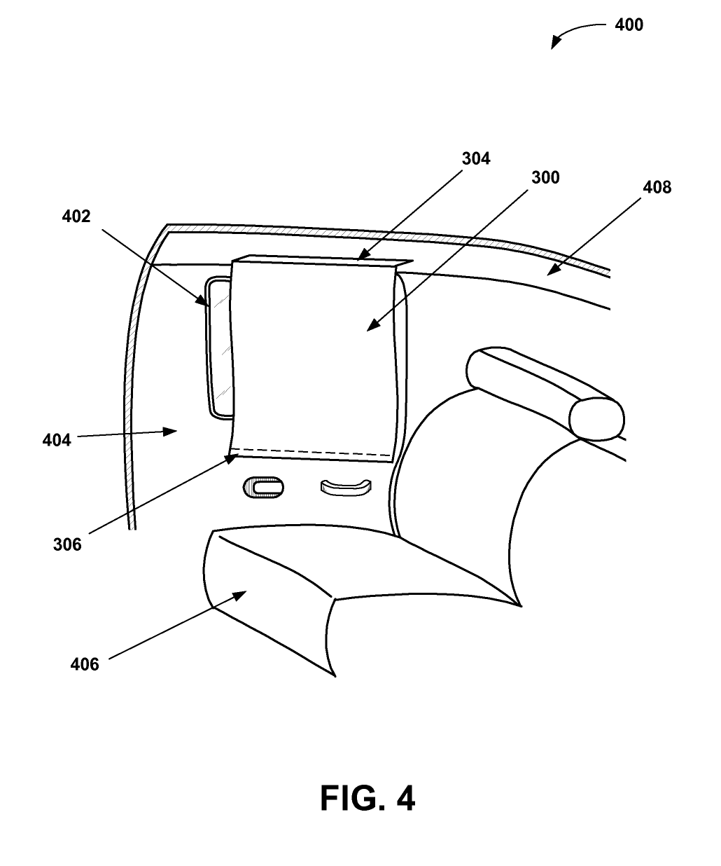

As with the temporary attachment means 304, the adjustment means 306 can also be formed of a length of hook material often utilized in a hook and loop fastener. Using the attachment means 304 and optionally the adjustment means 306, the vehicle window shade 300 of the embodiments of the present invention can be easily attached near a window to provide shade and concealment to the interior of the vehicle, as illustrated next with reference to FIG. 4.

FIG. 4 is an illustration showing a vehicle interior 400 having an exemplary vehicle window shade 300, in accordance with an embodiment of the present invention. As shown in FIG. 4, a typical vehicle interior 400 includes a vehicle window 402 disposed in a vehicle door 404, which generally is next to an interior seat 406, and over all is the vehicle ceiling 408. In general, the vehicle ceiling 408 is covered in an insulating material, such as felt, to reduce noise and help in maintaining optimum interior temperatures. Since felt is a non-woven cloth typically produced by matting, condensing and pressing woolen fibers, felt has much of the same characteristics of the loop portion of a hook and loop fastener. As a result, the hook material will attach to the felt in a manner similar to a hook and loop fastener.

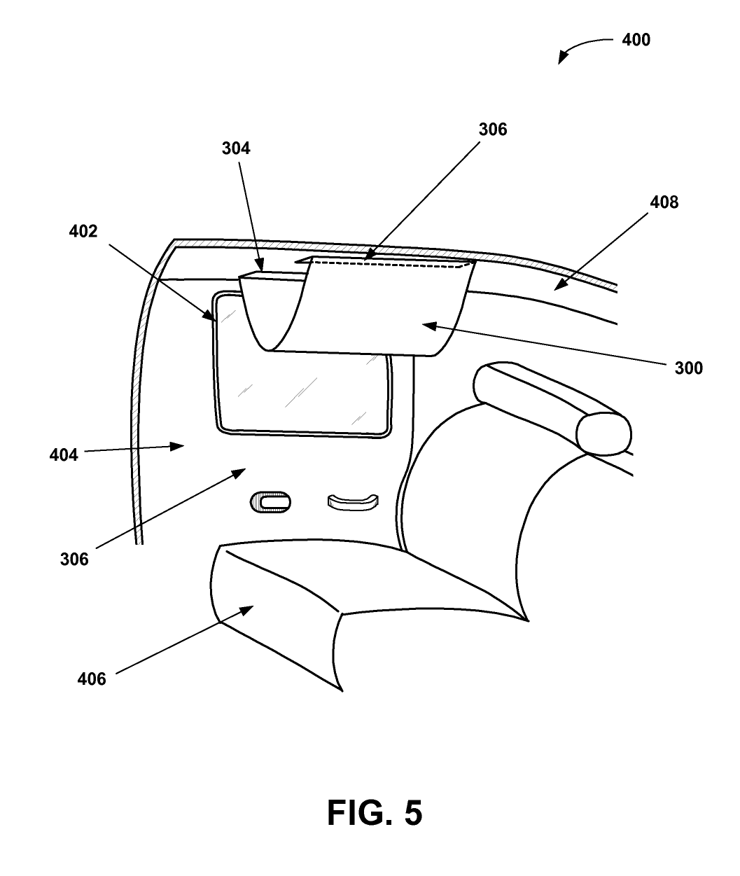

Embodiments of the present invention utilize the nature of this insulating material to attach the vehicle window shade 300 to the vehicle ceiling 408. More specifically, since the temporary attachment means 304 generally is formed from the hook material often utilized in a hook and loop fastener, the temporary attachment means 304 will adhere to the surface of the vehicle ceiling 408. That is, the small hooks on the hook material of the temporary attachment means 304 catch the felt material present on the vehicle ceiling 408 and hold vehicle window shade 300 in place. Later, when force is applied to separate the hook material of the temporary attachment means 304 from the vehicle ceiling 408, the hooks disengage from the felt surface of the vehicle ceiling 408 relatively easily. In addition to attaching the temporary attachment mean 304 to the vehicle ceiling 408, the effective length of the vehicle window shade 300 can be adjusted using the adjustment means 306, as described next with reference to FIG. 5.

FIG. 5 is an illustration showing a vehicle interior 400 having an exemplary vehicle window shade 300 adjusted using the adjustment means 306, in accordance with an embodiment of the present invention. As illustrated in FIG. 5, to adjust the length of the vehicle window shade 300 the adjustment means 306 can be attached to the vehicle ceiling 306. In this manner, the amount of light blocked or diluted by the vehicle window shade 300 can be controlled by attaching the adjustment means 306 to the vehicle ceiling 408 to adjust the length of the vehicle window shade 300. Moreover, to more securely attach the vehicle window shade 300 to an area near a window 402, the adjustment means 306 can be attached to a felt portion of the vehicle door 404. In this manner, the vehicle window shade 300 can be held securely in place even when the vehicle window 402 is down.

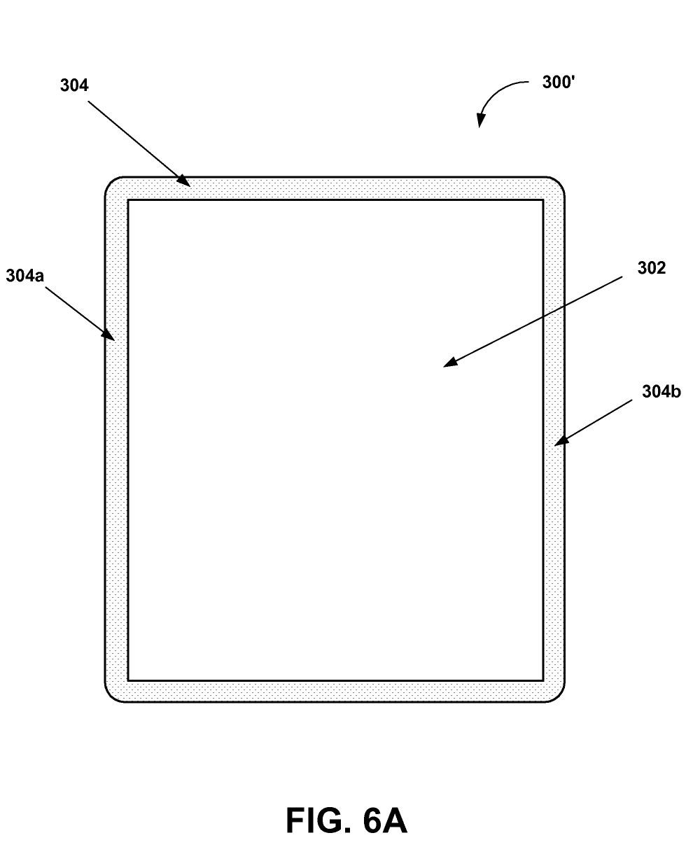

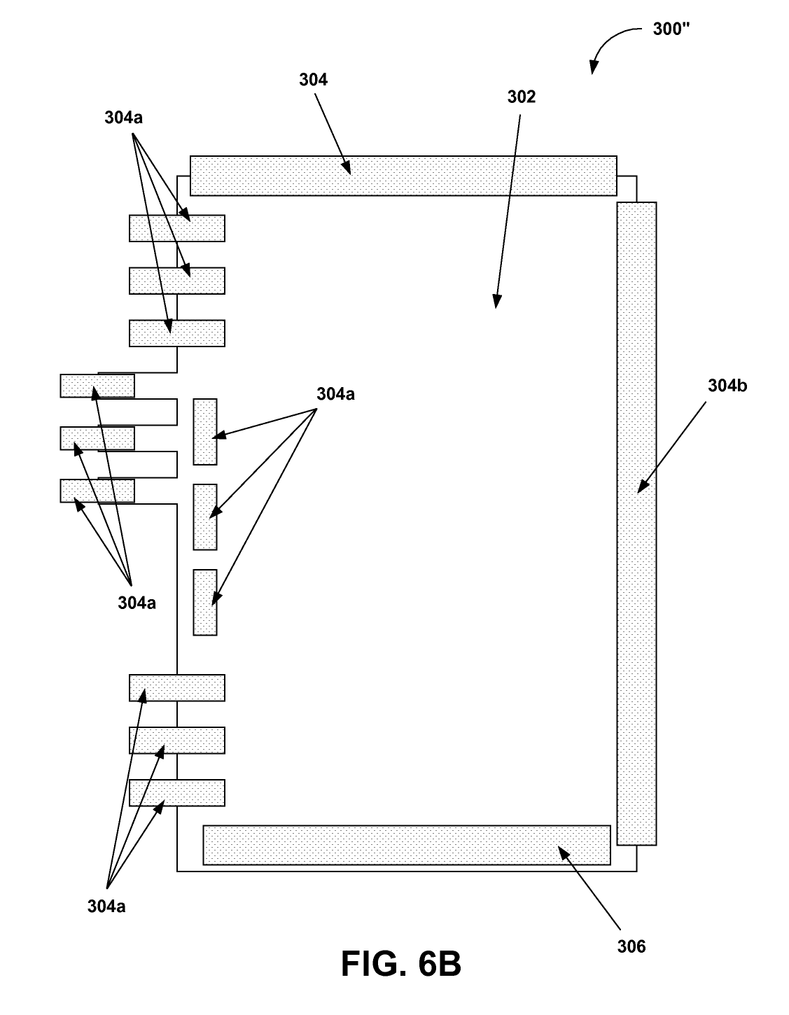

FIG. 6A is a diagram showing a first side of an exemplary vehicle window shade 300′ in accordance with an embodiment of the present invention. In this embodiment, the exemplary vehicle window shade 300′ includes an appropriately shaped section of flexible shade material 302 having a temporary attachment means 304 disposed around the entire edge of the flexible shade material 302 on the front side. The temporary attachment means 304 located at opposite edges of the flexible shade material 302 function in a similar manner to the embodiment described above with respect to FIG. 3. The temporary attachment means 304 located at the side edges 304a and 304b of the flexible shade material 302 are used to attach one vehicle window shade 300′ with another vehicle window shade 300′ using a felt backing, or any material with similar “loop” properties.

FIG. 6B is a diagram showing another example of a first side of an exemplary vehicle window shade 300″ in accordance with an embodiment of the present invention. As an alternative to FIG. 6A, FIG. 6B illustrates another arrangement of hook and loop material. In particular, the exemplary vehicle window shade 300″ includes an appropriately shaped section of flexible shade material 302 having a temporary attachment means 304 disposed at the top edge of the flexible shade material 302 on the front side. In addition, an adjustment means 306 is disposed at the bottom of the flexible shade material 302. The temporary attachment means 304 located at the side edges 304a and 304b of the flexible shade material 302 are used to attach one vehicle window shade 300″ with another vehicle window shade 300″ using a felt backing, or any material with similar “loop” properties. In the example of FIG. 6B however, the temporary attachment means 304 located at the left side edge 304a is divided into individual strips to allow for additional adjustment ability as needed by the user.

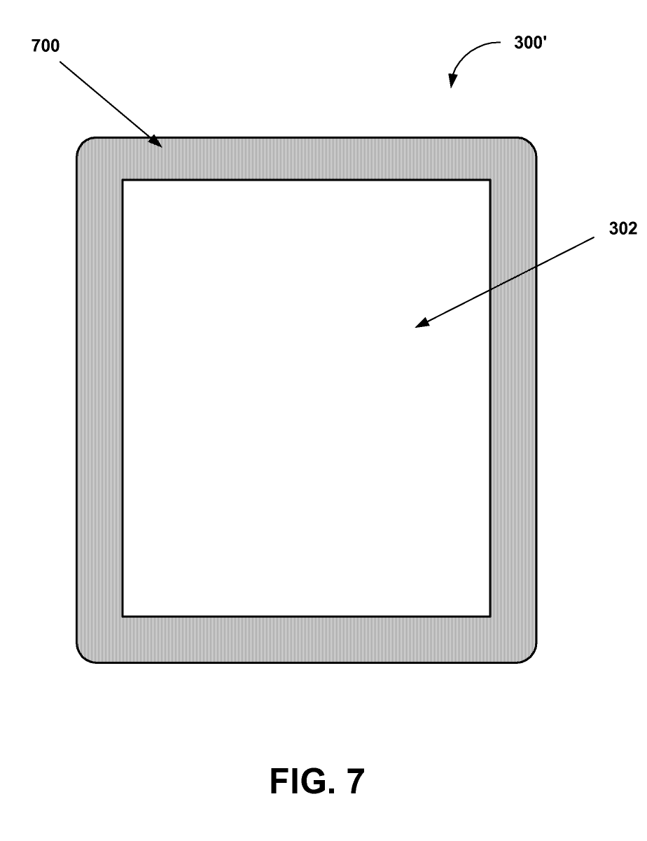

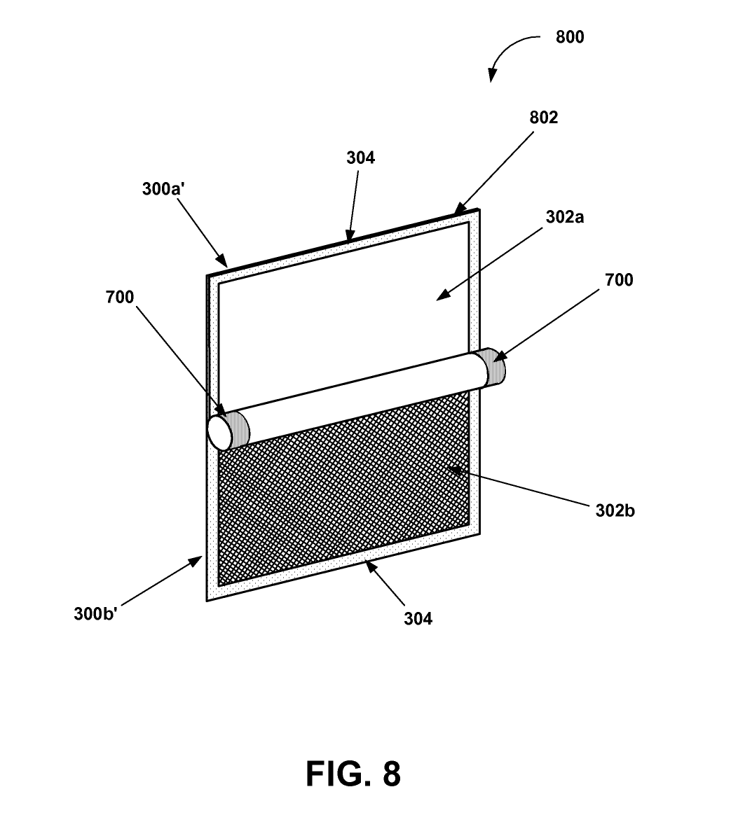

FIG. 7 is a diagram showing a second side of an exemplary vehicle window shade 300′, in accordance with an embodiment of the present invention. More specifically, FIG. 7 shows the reverse side of the vehicle window shade 300′ illustrated in FIG. 6A. The reverse side of the vehicle window shade 300′ includes a “loop” material having “loop” properties, such as felt 700 disposed around the entire edge of the flexible shade material 302. As mentioned previously, the felt 700, or any material with similar “loop” properties, is a non-woven cloth typically produced by matting, condensing and pressing woolen fibers, and as such has much of the same characteristics of the loop portion of a hook and loop fastener. As a result, the hook material disposed around the edges of the flexible shade material 302, as illustrated in FIG. 6A, will attach to the felt 700, or any material with similar “loop” properties, located on the reverse side of another vehicle window shade 300′ in a manner similar to a hook and loop fastener. In this manner, multiple vehicle window shades 300′ can be attached to each other to form a larger vehicle window shade. This type of vehicle window shade 300′ can be further combined to create a vehicle window shade having variable opacity and diaphaneity, as described next with reference to FIG. 8.

FIG. 8 is a diagram showing a vehicle window shade 800 having variable opacity and diaphaneity, in accordance with an embodiment of the present invention. The vehicle window shade 800 is formed from multiple vehicle window shades 300a′ and 300b′ overlaying each other. In the exemplary embodiment of FIG. 8, vehicle window shade 300a′ includes a flexible shade material 302a that is, for example, opaque or has a high level of opacity, such as a solid fabric. In the present description a higher level of opacity refers to something preventing more light from coming through it than one with a lower level of opacity. Vehicle window shade 300b′ includes a flexible shade material 302b that is, for example, diaphanous, such as a mesh fabric. Each vehicle window shade 300a′ and 300b′ includes a temporary attachment means 304 disposed around the edge of the flexible shade material 302 on one side and felt 700, or any material with similar “loop” properties, disposed around the edge of the flexible shade material 302 on the other side, as described with reference to FIG. 6A and FIG. 7. Referring back to FIG. 8, the two vehicle window shades 300a′ and 300b′ are attached at one end, for example, along the top edge 802. This attachment can be permanent, such as by being sewn together, or temporary, such as by having the temporary attachment means 304 of vehicle window shade 300b′ attached to the felt 700, or any material with similar “loop” properties, of vehicle window shade 300a′.

Vehicle window shade 800 is created by overlaying vehicle window shade 300a′ with vehicle window shades 300b′ such that the temporary attachment means 304 of vehicle window shade 300b′ attaches to the felt 700, or any material with similar “loop” properties, present on the reverse side of vehicle window shade 300a′. Once attached to one another, vehicle window shades 300a′ and 300b′ can operate as a single vehicle window shade 800. Hence vehicle window shade 800 can be attached near a vehicle window via the temporary attachment means 304 of vehicle window shade 300a′, as illustrated in FIG. 3. In addition, the effective length of vehicle window shade 800 can be adjusted in a manner similar to that described with respect to FIG. 5. Moreover, the effective length of vehicle window shade 800 can be adjusted by rolling one end of the vehicle window shade 800 until the desired length is achieved. When rolled together, the felt 700, or any material with similar “loop” properties, present on one side of vehicle window shade 300b′ will attach to the temporary attachment means 304 of vehicle window shade 300a′ thus keeping the vehicle window shade 800 from unrolling until force is applied to unroll the window shade.

Moreover, the opacity of the vehicle window shade 800 can be adjusted by rolling up only vehicle window shade 300a′ while vehicle window shade 300b′ remains unrolled and thus down. Similar to above, when rolled up, the felt 700, or any material with similar “loop” properties, present on one side of vehicle window shade 300a′ will attach to the temporary attachment means 304 of vehicle window shade 300a′ thus keeping the vehicle window shade 300a′ from unrolling until force is applied to unroll the window shade. In this manner, exemplary vehicle window shade 800 can be adjusted to be opaque, when both vehicle window shade 300a′ and 300b′ are down, diaphanous, when vehicle window shade 300a′ is rolled up and when vehicle window shade 300b′ is down, or clear, when both vehicle window shade 300a′ and 300b′ are up.

Although most vehicles today include felt covered vehicle ceilings, some older vehicles do not. However, most vehicles include a ⅛ to ¼ of an inch of exposed metal around the vehicle windows. Hence, a further embodiment of the present invention includes a temporary attachment means formed of Neodymium magnets. In this embodiment, the magnets can be incorporated into a magnet strip, which is a strip of hook material that is about 1 inch in width with various lengths to accommodate different size windows, including the windshield of a vehicle. In use, the magnet strip is attached to a vehicle window shade, and then the magnetic strip is attached to the exposed metal around the desired window.

Another attachment mechanism that can operate in an environment such as that described above, is an adhesive hook and loop strip. An adhesive hook and loop strip is essentially a section of hook and loop material wherein an adhesive material is included on the back side of the hook material and/or the loop material.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A vehicle window shade, comprising:
a section of fabric having a front side and a reverse side;
a temporary attachment means disposed on an edge of the fabric on the front side of the fabric, wherein the temporary attachment means is capable of attaching to a particular material when coming into contact with the particular material; and
a length of loop material disposed on an edge of the fabric on the reverse side of the fabric.

2. The vehicle window shade as recited in claim 1, wherein the loop material is felt.

3. The vehicle window shade as recited in claim 1, wherein the temporary attachment means is hook material, and the particular material is felt, wherein an end of the vehicle window shade can be attached to a vehicle ceiling via the hook material.

4. The vehicle window shade as recited in claim 1, wherein the section of fabric is opaque.

5. The vehicle window shade as recited in claim 1, wherein the section of fabric is diaphanous.

6. A vehicle window shade, comprising:
a section of fabric having a front side and a reverse side;
a hook material disposed around the entire edge of the fabric on the front side of the fabric, wherein the hook material is capable of attaching to felt when coming into contact with the felt; and
a length of felt disposed around the entire edge of the fabric on the reverse side of the fabric,
wherein an end of the vehicle window shade can be attached to a vehicle ceiling via the hook material.

7. The vehicle window shade as recited in claim 6, wherein the section of fabric is opaque.

8. The vehicle window shade as recited in claim 6, wherein the section of fabric is diaphanous.

9. A vehicle window shade, comprising:
a first piece of fabric having a front side and a reverse side;
a second piece of fabric attached at one end to the first piece of fabric, wherein the second piece of fabric includes a front side and a reverse side;
a first quantity of hook material disposed around the edge of the front side of the first piece of fabric;
a second quantity of hook material disposed around the edge of the front side of the second piece of fabric;
a first quantity of felt disposed around the edge of the reverse side of the first piece of fabric; and
a second quantity of felt disposed around the edge of the reverse side of the second piece of fabric,
wherein an end of the vehicle window shade can be attached to a vehicle ceiling via the first quantity of hook material.

10. The vehicle window shade as recited in claim 9, wherein the first piece of fabric has a higher level of opacity than the second piece of fabric.

11. The vehicle window shade as recited in claim 10, wherein the first piece of fabric is opaque.

12. The vehicle window shade as recited in claim 9, wherein the second piece of fabric is diaphanous.

13. The vehicle window shade as recited in claim 12, wherein the second piece of fabric is a mesh fabric.

14. The vehicle window shade as recited in claim 9, wherein the second piece of fabric overlays the first piece of fabric when both sections of fabric are unrolled.

15. The vehicle window shade as recited in claim 14, wherein the first piece of fabric can be rolled up while the second piece of fabric is left unrolled.
